(19) United States
(12) Patent Application Publication
(10) Pub. No.: US 2008/0133257 A1
(43) Pub. Date: Jun. 5, 2008

(54) Donating through affiliate marketing

(76) Inventors: Matthew Adkisson, Boston, MA (US); Justin Holland, Boston, MA (US); Casey Adkisson, Severna Park, MD (US)

Correspondence Address: FISH & RICHARDSON PC, P.O. BOX 1022, MINNEAPOLIS, MN, 55440-1022, US

(21) Appl. No.: 11/634,038

(22) Filed: Dec. 5, 2006

(51) Int. Cl. G06Q 99/00

(52) U.S. Cl. 705/1

(57) ABSTRACT

Donations are provided to a regulated organization by receiving value derived from activities of a user, automatically determining rules applicable to donations to the organization, and automatically providing at least some of the value to the organization in a manner consistent with the applicable rules.

Donations are dispersed to a regulated organization by receiving value derived from activities of a user, automatically placing the value in an escrow account, providing the user an opportunity to control dispersal of the value, and if the user does not prevent dispersal of the value to the organization, delivering the value to the organization.

### TECHNICAL FIELD

This disclosure relates to donating through affiliate marketing.

### BACKGROUND

Affinity shopping is a popular way to raise money for charitable organizations. Under some systems, users register at an online shopping website and specify charities that they would like to benefit. By shopping through that website, users generate affiliate commissions for the website's operators. The operators share a portion of those commissions with the users' indicated charities. Under other systems, a charity provides a link to an external shopping website. When users follow that link to access that shopping website instead of accessing it directly, the referring charity receives a commission on the users' purchases. Other sources of revenue include affinity searching, where a user searches the internet through a web page other than a standard search engine, and the revenue generated (e.g., through advertising or paid search results) is directed to some charity, paid surveys and research projects, and viewing advertising.

Certain types of organizations that people might wish to support in this manner are strictly regulated as to how and from whom they can receive donations. In particular, contributions to political candidates, political action committees, and certain nonprofits that are politically active are regulated by federal and state political fundraising and campaign financing laws. We sometimes refer to such parties as regulated political organizations. In many cases, personal identification is required from the person or party donating the money. The amount of information can vary based on the amount of the donation. For instance, in the case of an individual, a small (i.e., less than $200) donation to a Federal candidate requires the individual to provide his name and mailing address. [cite] If the contribution exceeds $200, he must provide his name, mailing address, occupation, and employer's name. Dollar limits and information required vary state to state and federally and may change over time.

Laws may also regulate certain formalities about how donations are made. For individual example, it may be required that a donation come directly from the personal assets of an dual, not from a business or other organization

### SUMMARY

In general, in one aspect, donations are provided to a regulated organization by receiving value derived from activities of a user, automatically determining rules applicable to donations to the organization, and automatically providing at least some of the value to the organization in a manner consistent with the applicable rules.

Implementations may include one or more of the following features.

Receiving value derived from activities of the user includes receiving affiliate marketing commissions derived from purchases made by the user. Receiving value derived from activities of the user includes receiving commissions derived from on-line activities of the user. The on-line activities of the user include one or more of shopping, searching, viewing advertisements, participating in surveys, or participating in market research. Receiving value derived from activities of the user includes receiving instructions from the user to make a purchase, routing the instructions to a vendor, and collecting value associated with the purchase from the vendor.

The rules include limits on the amount that an individual may donate. Providing at least some of the value to the organization in a manner consistent with the applicable rules includes automatically determining an amount of the value that the user has previously donated to the organization. Providing at least some of the value to the organization in a manner consistent with the applicable rules also includes automatically determining whether the amount of value derived from activities of the user plus the amount the user has previously donated would exceed a threshold, and if the threshold would be exceeded, automatically requesting that the user select a different organization to receive the value derived from activities of the user. Providing at least some of the value to the organization in a manner consistent with the applicable rules also includes automatically determining whether the amount of value derived from activities of the user plus the amount the user has previously donated would be less than a threshold, and automatically allowing the value to be donated to the organization if the threshold is not exceeded.

The rules include constraints on the identity of donors. Providing at least some of the value to the organization in a manner consistent with the applicable rules includes determining the identity of the user, automatically determining whether the user is permitted to donate to the organization, and providing the value to the organization only if the user is permitted to donate to the organization. The rules include requirements that information be collected from donors. The rules include requirements that varying minimum amounts of information be collected from donors based on the amount of their donation. Providing at least some of the value to the organization in a manner consistent with the applicable rules includes collecting a first quantum of information from the user, automatically determining whether the amount of the donation exceeds a first threshold, and if the amount exceeds the first threshold, automatically collecting a second quantum of information form the user. Providing at least some of the value to the organization in a manner consistent with the applicable rules includes automatically placing the value in an escrow account, and providing the user an opportunity to control the dispersal of the value after the value have been deposited in the escrow account. Providing at least some of the value to the organization in a manner consistent with the applicable rules also includes, after a defined period of time passes, automatically transferring the value to the organization.

Receiving from the user an identification of two or more organizations, and providing the value to the organization includes providing a subset of the value to each of the two or more organizations. Providing data to the organization including an identification of one or more users for whom value was provided to the organization. Providing the data includes enabling the organization to access the data on the computer system. Providing data includes receiving from the organization an identification of a data format, and formatting data according to the data format. Providing the data also includes transmitting a file containing the formatted data to the organization. Providing the data also includes transmitting a file containing the formatted data to a third party specified by the organization. Determining requirements for donations determined by the organization, and providing the value to the organization in a manner consistent with the requirements determined by the organization. Providing the data includes displaying the data in a manner that relates a first field of data to an amount of value that was provided to the organization

Providing the value to the organization in a manner consistent with the requirements determined by the organization includes receiving a list of eligible donors from the organization comparing an identity of the user to the list, and if the user is on the list, allowing the value to be donated to the organization. Providing the value to the organization in a manner consistent with the requirements determined by the organization also includes requesting that the organization approve or reject the user. Providing the value to the organization in a manner consistent with the requirements determined by the organization includes receiving a list of ineligible donors from the organization comparing an identity of the user to the list, and if the user is on the list, requesting that the user select a different organization to receive the value. Providing the value to the organization in a manner consistent with the requirements determined by the organization includes receiving criteria describing eligible donors from the organization comparing information describing the user to the criteria, and based on the comparison, allowing the value to be donated to the organization or requesting that the user select a different organization to receive the value.

Maintaining a database of the rules, associating metadata with the rules, the metadata describing the applicability of the rules to donations, donors, or recipients. Providing at least some of the value to the organization in a manner consistent with the rules includes accessing the database of rules to identify rules applicable to a proposed donation. The identifying of rules applicable to a proposed donation is based on one or more or a combination of the amount of the donation, an attribute of the organization, or an attribute of the user. Providing at least some of the value to the organization in a manner consistent with the rules includes accessing the database of rules to identify rules applicable to the user. Providing at least some of the value to the organization in a manner consistent with the rules includes accessing the database of rules to identify rules applicable to the organization. wherein providing at least some of the value to the organization in a manner consistent with the rules includes determining whether the user is a natural person. The value includes money. The value includes credits. The value includes non-monetary value. The rules include laws or regulations.

In general, in one aspect, donations are dispersed to a regulated organization by receiving value derived from activities of a user, automatically placing the value in an escrow account, providing the user an opportunity to control dispersal of the value, and if the user does not prevent dispersal of the value to the organization, delivering the value to the organization.

Implementations may include one or more of the following features. Delivering the value to the organization includes requesting a wire transfer of value from the escrow account to a bank account associated with the organization. The write transfer is a delayed wire transfer, and also including the user the ability to cancel the delayed wire transfer after it has been requested. Detecting whether the user has cancelled the delayed wire transfer, and if the user has cancelled the delayed wire transfer, providing the user an opportunity to receive the value.

In general, in one aspect, donations are dispersed to a regulated organization by receiving value derived from activities of a user, determining the identity of the user, automatically determining whether the organization is willing to accept donations from the user, if the organization is willing to accept donations from the user, transferring the value to the organization.

In general, in one aspect, communications are provided from an organization to a user by receiving value derived from activities of the user, receiving information characterizing the user, receiving a communication from the organization and a set of criteria, automatically determining whether the value or the information match the criteria, and if the value or the information match the criteria, automatically providing the communication to the user.

Other features and advantages of the invention will be apparent from the description and the claims.

### BRIEF DESCRIPTION OF THE DRAWINGS

FIG. 1 shows a block diagram of a computer system.

FIGS. 2, 3A, and 3B are flow charts.

### DESCRIPTION

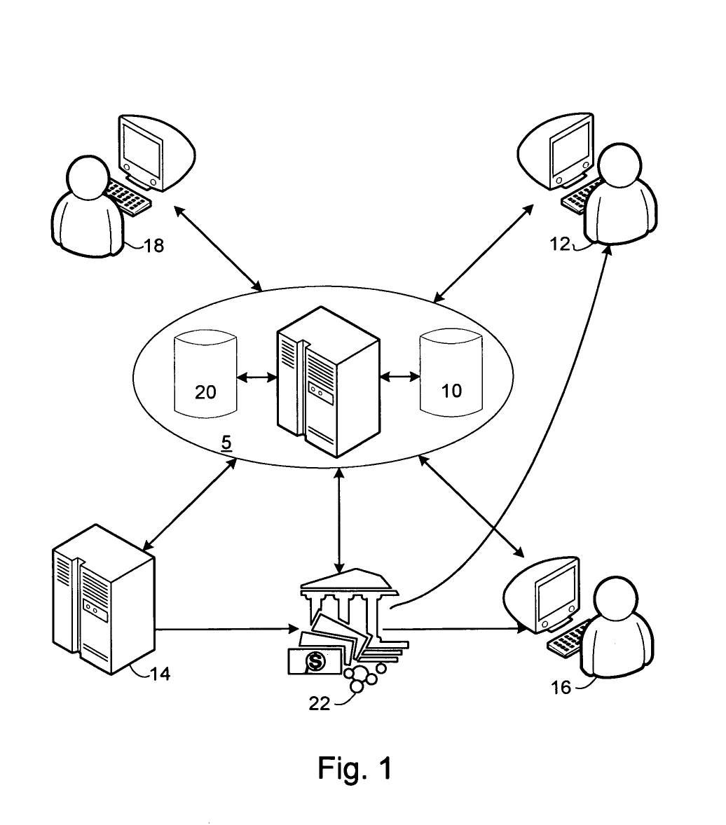

Affinity shopping commissions can be made “donatable” to regulated political organizations by collecting certain information from the users generating the commissions and structuring the flow of assets and information in particular ways to comply with political or other financing regulations. In some examples, a database is used to track information such as contribution limits and details about registered users and their donation amounts, and to make sure that all the required information is collected and is delivered to the proper parties. As shown in FIG. 1, a central donation system 5 includes a database 10 and coordinates the activities of users 12, affiliate sites 14, and donees 16. The donation system 5 gathers the information from users that is required for them to make political contributions. It receives information from the affiliate sites about the funds that are generated, and its operator 18 may receive the funds itself or may direct their distribution without handling them directly, for example, through bank 22. The donation system 5 also may receive information from the donees 16 about what regulations apply to them and any preferences they have for handling donations. It provides the donees 16 with the information gathered from the users 12 and affiliates 14, as appropriate. In cases where the operator 18 or the donation system 5 receives the commissions directly, it may then provide them to the donees 18 or to the users 12, as described below.

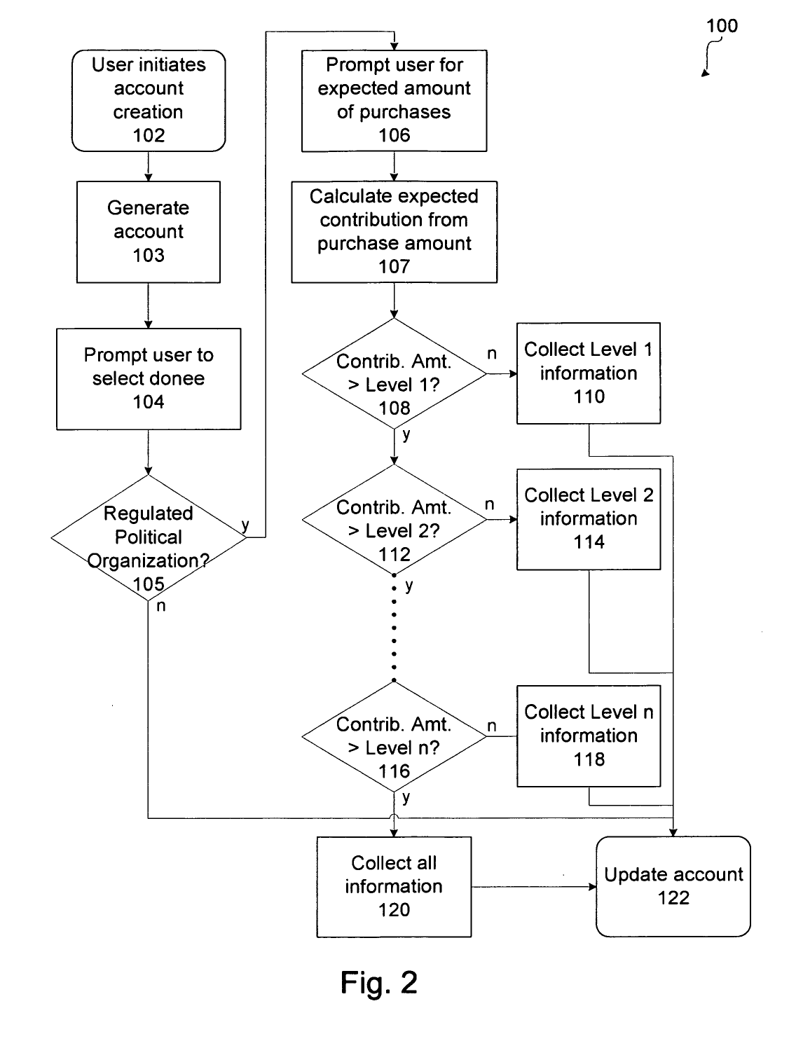

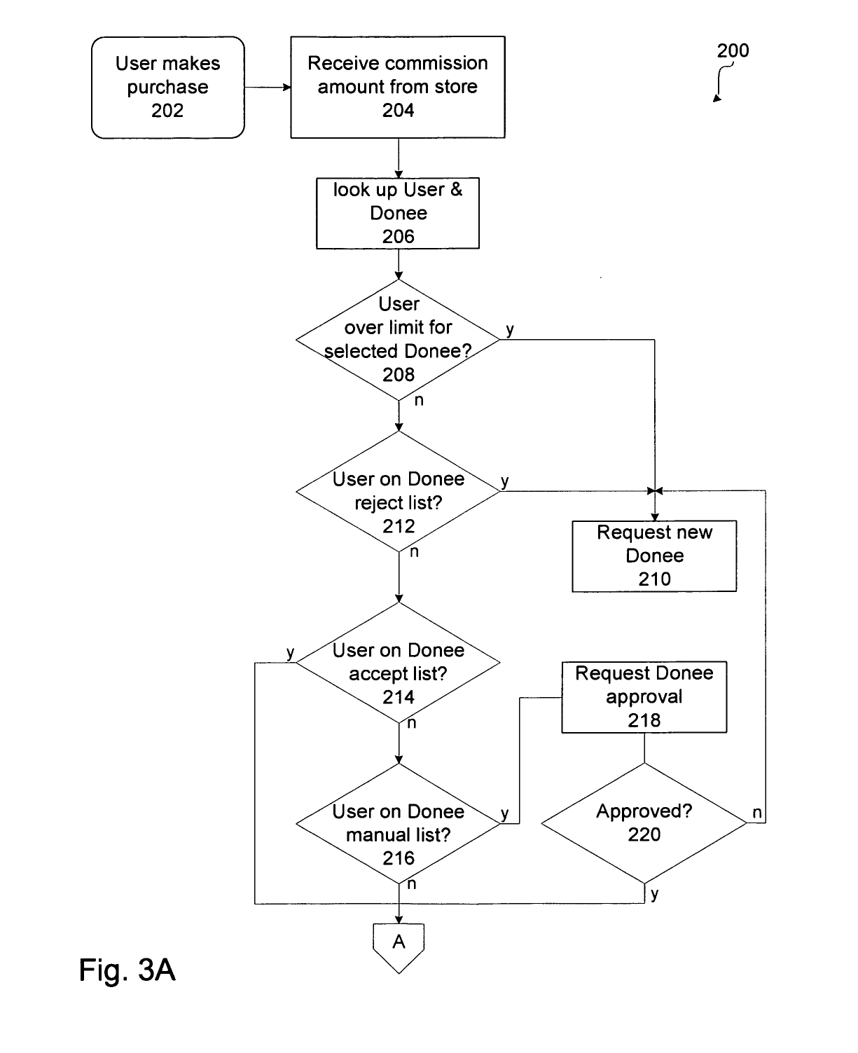

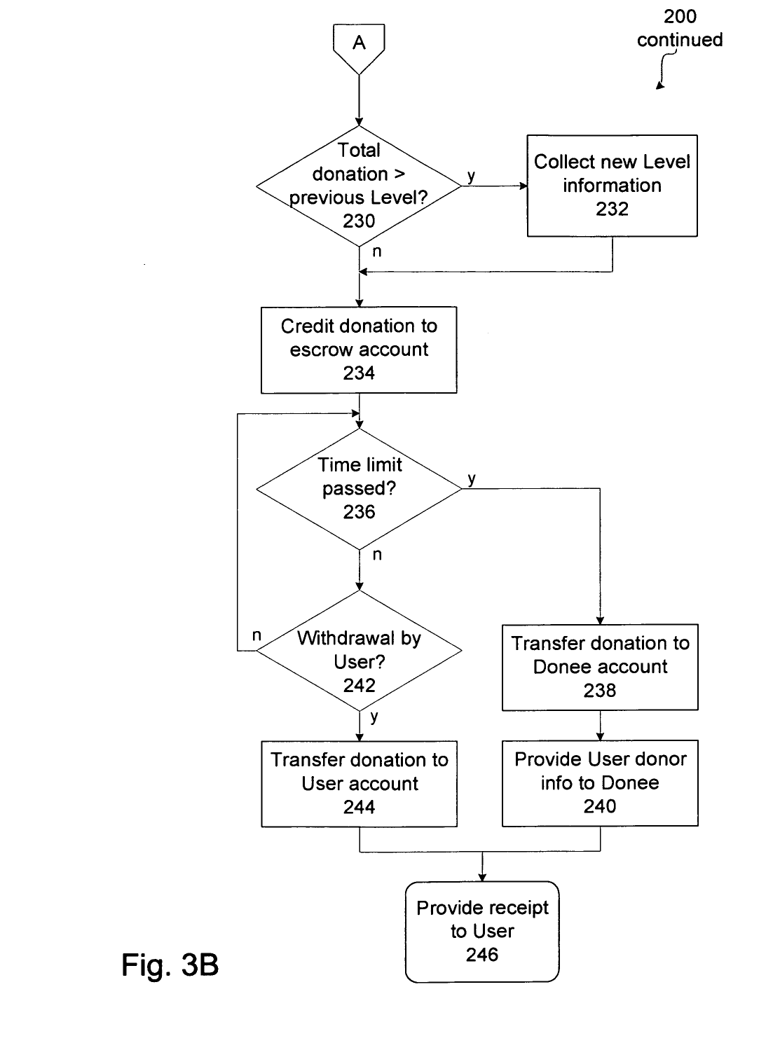

The donation system 5 interacts with the user 12 through a website. This may be a website specifically used for making donations through the donation system 5, or it may be a component of a website operated (at least as far as the user is aware) by the donee 18 or some other third party (not shown). When a new user 12 comes to the site, the process 100 in FIG. 2 is carried out.

At the user 12's initiation (102), an account is created (103). The user 12 is prompted (104) to choose a type of organization 16 to support. This could be a charitable organization, a political candidate, or others. If the user 12 chooses to support a regulated political organization (105), then he is prompted to estimate his annual spending amount (106). This is needed to estimate how much the user will ultimately donate through affinity commissions over the course of the year (107). The process 100 next determines what information is required from the user in order to donate the estimated amount to the selected organization. For example, if the user is donating less than a first level (108), which we refer to as Level 1, then only a small amount of information is needed. This information is then collected (110) from the user. For increasing donation levels (112, 116), increasing amounts of information are collected (114, 118, 120). The actual number of levels and information required will depend on the nature of the recipient 16 and the specific laws or regulations that apply. The recipient organizations may also specify information that is required from donors, for example, a political campaign may require complete information from any donor, rather than following the tiers of information they are required to collect by campaign finance laws. Once the necessary information has been collected, the account is updated (122).

After the user account is created, the user can make purchases or engage in other activities (e.g., viewing advertisements, completing surveys) that generate affiliate commissions. As these commissions are collected, several processes control their distribution, as shown in a process 200 in FIGS. 2A and 2B. When a user makes a purchase (202) or otherwise generates a commission, that commission is received (204) from the store or other body providing it. The database 10 is used to look up the user 12's account and information about the donee 16. For some types of contributions, there is a fixed upper limit on how much one person can donate, for example, an annual limit on the amount an individual can contribute to a political candidate. The databases system 10 checks (208) whether the commissions accrued to the user so far this year (or in some other relevant time period) exceed any limits applicable to the selected donee. If they do, the user is prompted (210) to select a new donee to receive the excess.

Some political organizations and other charities may encounter legal or political problems from accepting contributions from certain individuals or groups. For example, a candidate for state office may be prohibited from accepting donations from out of state, or an environmental lobbying organization may not want to receive donations from an oil company. To address these concerns, the system 5 may provide an interface that organizations can use in order to specify how they would like their donations to be handled. For example, they can configure filters that allow or disallow certain donors based on name, location (e.g., out of state), occupation, or other factors. For example, an organization might have a “reject list” of donors from whom they do not want to accept contributions. If someone on the reject list tries to direct contributions to that organization, their account may be frozen and the organization notified, via the web interface. The organization is given the opportunity to manually approve the user before the user can continue. An organization may also choose, for example, to let users register and generate contributions, but then have a representative from the organization access the web interface and manually approve each donation. Several such filters are shown in FIG. 2A—step 212 checks whether the user is on a reject list, step 214 checks whether he is on an accept list, and step 216 checks whether the user is on a list of donors who require manual approval. If step 212 rejects the user, he is asked (210) to select a new recipient of his commissions. For users on the manual approval list, the donee is asked to approve the user (218). If approval is granted, the process may continue; if it is denied, the user is asked to select a new donee (210). Many other filters and safeguards are possible—the examples in FIG. 2A are provided only for illustration.

After the user has passed whatever checks his chosen recipient has put in place, the process 200 continues as shown in FIG. 2B. The user's accumulated donation is compared (230) to the level that was predicted in process 100. If it is exceeded, additional information required by the actual donation level is collected (232). Further donations based on that use's actions may be frozen until the information is provided.

Under some regulations applicable to political or charitable donations, money donated by a particular individual has to legally be that individual's own money. In practical effect, this means that the commissions generated by the affiliate sites 14 have to be given to the user 12 before they can be donated to the recipient 16. Similar rules apply for donations to be tax deductible. In order to achieve this, process 200 transfers (234) the money raised by a user into an escrow account that is under the control of the user. From this account, the user can initiate an electronic wire transfer 244 to his own account or in some other appropriate way withdraw the funds. Depending on the details of the laws applicable to the recipient 16, requirements for user control of the donation may be satisfied if the user can exchange the donation for credit in the store that generated the commission in the first place (this may be desirable, for example, if the organizations involved do not want to directly provide cash to individuals).

In some examples, if the user takes no action in a certain time period (236), the money in the escrow account is automatically transferred (238), in the user 12's name and on his behalf, to the recipient 16. The donee is provided (240) information about the User, as required by applicable reporting regulations. Once the money is distributed, the user is given a receipt (246).

In some examples, when the money is placed in the escrow account, a “delayed wire transfer” order is put on it, such that if the user takes no action to withdraw the money, it will be sent to the organization at the end of a certain time period (e.g., 14 days). The user could cancel the delayed wire transfer and instead initiate a wire transfer to himself or someone else. This allows steps 236, 242, and 238 to be carried out automatically without the system 5 having to monitor whether the user has withdrawn the money. This can be advantageous where the system 5 is designed to control the flow of funds but not to hold them.

In some examples, the money is transferred using the existing Automated Clearing House (ACH) network for wire transfers. This network is regulated by the National ACH Association (NACHA). The system 5 generates a so-called NACHA file which lists a recipient's name, bank account information, and donation amount in each of one or more lines. This file is uploaded to the bank 22 which inputs it into the ACH clearinghouse and initiates ACH transfers for each line of the NACHA file through an automated process. The NACHA file may contain donations for all the organizations supported by the system 5, or just one, or any combination. It can be generated at the end of each day or some other period, or a file can be generated on-demand when requested by a recipient or other user.

If the donation is approved (manually or automatically), the database 10 outputs the data in a format compatible with that used by the recipient. For example, various software vendors provide accounting software for political organizations that is designed to facilitate compliance with Federal Election Commission (FEC) regulations. The output of the database 10 can be formatted to be compatible with such software. In some examples, the donation system provides a web-based interface through which the recipient 18 is able to automatically and dynamically generate whatever reports it needs, for example, it may generate reports of all the donations it has received or a specified sub-set of donations. For web-based regulatory-compliance software platforms, the recipient 18 can provide information to allow the donation system 5 to automatically log in to the recipient's system or its account with a third-party provider and integrate donation information directly into the recipient's records. For non-web-based compliance platforms, the recipient may have to manually integrate the data. For example, the system 5 may generate a reporting file in a format specified by the vendor of the compliance format, and transmit this file to the recipient 18. The recipient 18 can then input that file into their own system in whatever manner it prefers.

In some examples, the recipient 18 may input to the web interface information on users who are close to or at their donation limits as a filter against further donations. This may be useful if the donor has made donations both directly and through the donation system, thus the information the database 10 regarding the amount donated is not accurate. This can help assure that the recipient does not violate any laws and has full control over who it accepts money from. Outside donation information may also be retrieved from the FEC or other government organizations. The FEC sometimes publishes a data file showing all donations to all the candidates it regulates. The system 5 can retrieve this file and integrate it into the database 10 to supplement the information already in that database and help keep the information up-to-date and complete.

In some examples, a user may not know what organization he wishes to donate to or is eligible to donate to when he creates his account. Recipients may wish to monitor donations levels and applicable regulations without having to cross-reference donations and regulations on their own. To address these and similar concerns, the donation system 5 may include a database 20 of applicable regulations that includes metadata associated with the regulations indicating what types of organizations they apply to, what donation amounts they describe, and similar information. This allows the system 5 to rapidly identify which regulations are applicable based on information about an organization, a user, or the amount of money in question. For example, a user who has accrued a certain amount of money may inquire what organizations he may donate it to. Based on the amount, the system 5 can look up in the database 20 which regulations would apply. It may then display to the user a list of organizations to which he may donate the accrued amount, and identify whether he would be required to provide additional information in order to legally donate to any of them. It may also indicate that while he would have to provide more information to donate the entire amount to a political candidate, he can split the amount between several candidates without providing more information, or he may donate it to a charity instead.

For a recipient, the database 20 may be used to show the recipient which regulations apply to any donations that it has already received and which will apply to any pending or potential donations. If a given user 12 has selected an organization but the organization has required approval of that donation as described above, the database 20 may be accessed to show the organization recipient which regulations apply to the donation based on the current amount that user has raised. For example, it may show that the organization will be required to file certain documentation with a regulatory agency if it accepts this user's donation, or it may show that the organization will be not eligible for particular grants if the donation increases beyond its current level.

In some examples, as funds are being raised and donations made, organizations may also use the system to communicate with their supporters. This is especially useful if the site through which users raise funds is the sort of site, such as a search engine or a web portal, that users come to every day. Each organization a user supports may post messages on such a site that will be seen only by their own supporters. The data collected in the course of fundraising may be used to further refine such a system, for example, a political campaign may wish to send a message encouraging it supporters in one state to vote, while in another state it is more pressing to encourage supporters to donate to the candidate in the first state. An organization may also want to tailor its messages based on how much has been donated by different users. Any of the criteria collected in the process of raising the funds and making the donations could be leveraged in filtering and targeting such communications.

An organization may also use the data available through the system to perform detailed analysis of donation patterns. For example, the system may provide a political campaign with an interactive map showing the locations of its supporters overlaid on congressional districts. Such a map could sort the donors according to how much they have donated, their political affiliation, or any other data collected by the system. Data could also be presented in other graphical forms or tabular forms, or any other way of presenting and analyzing data.

Other implementations are within the scope of the following claims and other claims to which the applicant may be entitled.

What is claimed is:

1. A method of providing donations to a regulated organization, the method comprising:
receiving value derived from activities of a user;
automatically determining rules applicable to donations to the organization; and
automatically providing at least some of the value to the organization in a manner consistent with the applicable rules.

2. The method of claim 1 in which receiving value derived from activities of the user comprises receiving affiliate marketing commissions derived from purchases made by the user.

3. The method of claim 1 in which receiving value derived from activities of the user comprises receiving commissions derived from on-line activities of the user.

4. The method of claim 3 in which the on-line activities of the user comprise one or more of shopping, searching, viewing advertisements, participating in surveys, or participating in market research.

5. The method of claim 1 in which receiving value derived from activities of the user comprises:
receiving instructions from the user to make a purchase,
routing the instructions to a vendor, and
collecting value associated with the purchase from the vendor.

6. The method of claim 1 in which the rules comprise limits on the amount that an individual may donate.

7. The method of claim 6 in which providing at least some of the value to the organization in a manner consistent with the applicable rules comprises:
automatically determining an amount of the value that the user has previously donated to the organization.

8. The method of claim 7 in which providing at least some of the value to the organization in a manner consistent with the applicable rules also comprises:
automatically determining whether the amount of value derived from activities of the user plus the amount the user has previously donated would exceed a threshold, and
if the threshold would be exceeded, automatically requesting that the user select a different organization to receive the value derived from activities of the user.

9. The method of claim 7 in which providing at least some of the value to the organization in a manner consistent with the applicable rules also comprises:
automatically determining whether the amount of value derived from activities of the user plus the amount the user has previously donated would be less than a threshold, and
automatically allowing the value to be donated to the organization if the threshold is not exceeded.

10. The method of claim 1 in which the rules comprise constraints on the identity of donors.

11. The method of claim 10 in which providing at least some of the value to the organization in a manner consistent with the applicable rules comprises:
determining the identity of the user;
automatically determining whether the user is permitted to donate to the organization; and
providing the value to the organization only if the user is permitted to donate to the organization.

12. The method of claim 1 in which the rules comprise requirements that information be collected from donors.

13. The method of claim 1 in which the rules comprise requirements that varying minimum amounts of information be collected from donors based on the amount of their donation.

14. The method of claim 13 in which providing at least some of the value to the organization in a manner consistent with the applicable rules comprises:
collecting a first quantum of information from the user,
automatically determining whether the amount of the donation exceeds a first threshold, and
if the amount exceeds the first threshold, automatically collecting a second quantum of information form the user.

15. The method of claim 1 in which providing at least some of the value to the organization in a manner consistent with the applicable rules comprises:
automatically placing the value in an escrow account, and
providing the user an opportunity to control the dispersal of the value after the value have been deposited in the escrow account.

16. The method of claim 15 in which providing at least some of the value to the organization in a manner consistent with the applicable rules also comprises:
after a defined period of time passes, automatically transferring the value to the organization.

17. The method of claim 1 also comprising:
receiving from the user an identification of two or more organizations, and in which
providing the value to the organization comprises providing a subset of the value to each of the two or more organizations.

18. The method of claim 1 also comprising:
providing data to the organization including an identification of one or more users for whom value was provided to the organization.

19. The method of claim 18 in which providing the data comprises enabling the organization to access the data on the computer system.

20. The method of claim 18 in which providing data comprises:
receiving from the organization an identification of a data format, and
formatting data according to the data format.

21. The method of claim 20 in which providing the data also comprises transmitting a file containing the formatted data to the organization.

22. The method of claim 20 in which providing the data also comprises transmitting a file containing the formatted data to a third party specified by the organization.

23. The method of claim 18 in which providing the data comprises displaying the data in a manner that relates a first field of data to an amount of value that was provided to the organization.

24. The method of claim 1 also comprising:
determining requirements for donations determined by the organization; and
providing the value to the organization in a manner consistent with the requirements determined by the organization.

25. The method of claim 24 in which providing the value to the organization in a manner consistent with the requirements determined by the organization comprises:
receiving a list of eligible donors from the organization comparing an identity of the user to the list, and
if the user is on the list, allowing the value to be donated to the organization.

26. The method of claim 24 in which providing the value to the organization in a manner consistent with the requirements determined by the organization also comprises:
requesting that the organization approve or reject the user.

27. The method of claim 24 in which providing the value to the organization in a manner consistent with the requirements determined by the organization comprises:
receiving a list of ineligible donors from the organization comparing an identity of the user to the list, and
if the user is on the list, requesting that the user select a different organization to receive the value.

28. The method of claim 24 in which providing the value to the organization in a manner consistent with the requirements determined by the organization comprises:
receiving criteria describing eligible donors from the organization comparing information describing the user to the criteria, and
based on the comparison, allowing the value to be donated to the organization or requesting that the user select a different organization to receive the value.

29. The method of claim 1 also comprising
maintaining a database of the rules,
associating metadata with the rules, the metadata describing the applicability of the rules to donations, donors, or recipients.

30. The method of claim 29 in which providing at least some of the value to the organization in a manner consistent with the rules includes:
accessing the database of rules to identify rules applicable to a proposed donation.

31. The method of claim 30 in which the identifying of rules applicable to a proposed donation is based on one or more or a combination of: the amount of the donation, an attribute of the organization, or an attribute of the user.

32. The method of claim 29 in which providing at least some of the value to the organization in a manner consistent with the rules includes:
accessing the database of rules to identify rules applicable to the user.

33. The method of claim 29 in which providing at least some of the value to the organization in a manner consistent with the rules includes:
accessing the database of rules to identify rules applicable to the organization.

34. The method of claim 1 wherein providing at least some of the value to the organization in a manner consistent with the rules comprises determining whether the user is a natural person.

35. The method of claim 1, wherein the value comprises money.

36. The method of claim 1, wherein the value comprises credits.

37. The method of claim 1, wherein the value comprises non-monetary value.

38. The method of claim 1, wherein the rules comprise laws or regulations.

39. A method of dispersing donations to a regulated organization, the method comprising:
receiving value derived from activities of a user,
automatically placing the value in an escrow account,
providing the user an opportunity to control dispersal of the value, and
if the user does not prevent dispersal of the value to the organization, delivering the value to the organization.

40. The method of claim 39 in which delivering the value to the organization comprises requesting a wire transfer of value from the escrow account to a bank account associated with the organization.

41. The method of claim 40 wherein the write transfer is a delayed wire transfer, and further comprising the user the ability to cancel the delayed wire transfer after it has been requested.

42. The method of claim 41, further comprising:
detecting whether the user has cancelled the delayed wire transfer; and
if the user has cancelled the delayed wire transfer, providing the user an opportunity to receive the value.

43. A method of dispersing donations to a regulated organization, the method comprising:
receiving value derived from activities of a user,
determining the identity of the user;
automatically determining whether the organization is willing to accept donations from the user;
if the organization is willing to accept donations from the user, transferring the value to the organization.

44. A method of providing communications from an organization to a user, the method comprising:
receiving value derived from activities of the user,
receiving information characterizing the user,
receiving a communication from the organization and a set of criteria,
automatically determining whether the value or the information match the criteria, and
if the value or the information match the criteria, automatically providing the communication to the user.

45. A computer readable medium comprising instructions to cause a computer to:
receive value derived from activities of a user;
automatically determine rules applicable to donations to the organization; and
automatically provide at least some of the value to the organization in a manner consistent with the applicable rules.

46. The computer readable medium of claim 45 in which the instructions cause the computer to provide at least some of the value to the organization in a manner consistent with the applicable rules by:
automatically placing the value in an escrow account, and
providing the user an opportunity to control the dispersal of the value after the value have been deposited in the escrow account.

47. The method of claim 46 in which the instructions also cause the computer to provide at least some of the value to the organization in a manner consistent with the applicable rules by:
after a defined period of time passes, automatically transferring the value to the organization.

48. The method of claim 45 in which the instructions also cause the computer to:
provide data to the organization including an identification of one or more users for whom value was provided to the organization.

49. The method of claim 45 in which the instructions also cause the computer to:
maintain a database of the rules,
associate metadata with the rules, the metadata describing the applicability of the rules to donations, donors, or recipients.

50. A computer readable medium comprising instructions to cause a computer to:
receive value derived from activities of a user,
automatically place the value in an escrow account,
provide the user an opportunity to control dispersal of the value, and
if the user does not prevent dispersal of the value to the organization, deliver the value to the organization.

51. The computer readable medium of claim 50 in which the instructions also cause the computer to:
detect whether the user has cancelled the delayed wire transfer; and
if the user has cancelled the delayed wire transfer, provide the user an opportunity to receive the value.

52. A computer readable medium comprising instructions to cause a computer to:
receive value derived from activities of a user,
determine the identity of the user;
automatically determine whether the organization is willing to accept donations from the user;
if the organization is willing to accept donations from the user, transfer the value to the organization.

53. A computer readable medium comprising instructions to cause a computer to:
receive value derived from activities of the user,
receive information characterizing the user,
receive a communication from the organization and a set of criteria,
automatically determine whether the value or the information match the criteria, and
if the value or the information match the criteria, automatically provide the communication to the user.
